(19) United States
(12) Patent Application Publication
(10) Pub. No.: US 2002/0112030 A1
(43) Pub. Date: Aug. 15, 2002

(54) Guaranteed data access speed of a storage system

(76) Inventors: Naoko Iwami, Cupertino, CA (US); Akira Yamamoto, Cupertino, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/742,157

(22) Filed: Dec. 19, 2000

(51) Int. Cl. G06F 15/16; G06F 15/173

(52) U.S. Cl. 709/219; 709/226; 707/10

(57) ABSTRACT

This invention provides techniques for guaranteeing data access speed of storage connected by a network having guaranteed QoS (Quality of Services). In a representative specific embodiment, communication speed and storage disks are assigned in order to accommodate user requested data access speed. The communication speed of data paths is assigned in order to accommodate the speed of storage system resources, such as the storage disks connected by these data paths. The storage disks are assigned in order to accommodate the speed of communication links that connect the storage system to other devices. Specific embodiments include a storage system that connects to a host computer system, and a storage system that connects with other storage systems. Specific embodiments provide guaranteed data access speed for storage, and use resources more efficiently.

### BACKGROUND OF THE INVENTION

This invention relates generally to guaranteed data access speed storage, and specifically to techniques for guaranteeing data access speed of storage that is connected to a network which provides guaranteed QoS (Quality of Services).

Conventionally, storage has been used in a geographically localized area such as a single building. Such storage is connected to a host using a limited set of short distance lines. While certain advantages are perceived, conventional approaches have provided relatively few choices of data access speed. For example, users are beginning to find advantages in accessing and using storage in a relatively wider geographic area. In some applications, connecting storage and host at a relatively long distance provides certain advantages. In such applications, storage is connected using a variety of network technologies, including the Internet.

There are many types of networks, which operate at a variety of communication speeds. Further, storage devices are continuously improving in capability and operating speed. Conventional approaches often suffer from inadequate storage throughput. Such storage systems do not have sufficient speed to meet user needs. For example, the user may not know the actual data access speed for a particular application. As a result, a relatively high speed storage may be connected to a relatively low speed network, or a relatively low speed storage may be connected to a relatively high speed network.

One approach to meeting users' needs for remote storage is the Storage Service Provider (SSP). The SSP provides storage, however the data access speed is not guaranteed. In conventional approaches, SSP resources may be wasted. Also, additional costs can be incurred. Thus, there are opportunities for further gains in efficiency and economy over conventional approaches.

Based upon the foregoing, what is really needed are improved techniques for guaranteeing the data access speed of storage connected by a network.

### SUMMARY OF THE INVENTION

This invention provides techniques for guaranteeing data access speed of storage connected by a network having guaranteed QoS (Quality of Services). In a representative specific embodiment, communication speed and storage disks are assigned in order to accommodate user requested data access speed. The communication speed of data paths is assigned in order to accommodate the speed of storage system resources, such as the storage disks connected by these data paths. The storage disks are assigned in order to accommodate the speed of communication links that connect the storage system to other devices. Specific embodiments include a storage system that connects to a host computer system, and a storage system that connects with other storage systems. Specific embodiments provide guaranteed data access speed for storage, and use resources more efficiently.

In a representative specific embodiment, the invention provides an apparatus comprising a processor; a storage; and a network connection. The network connection is operable to connect the apparatus to a variety of devices. The network provides a guaranteed quality of service (QoS) for communications using the network. The processor establishes a data path between the storage and the network connection. This data path is assigned a sufficient data speed in order to accommodate the guaranteed quality of service. In a specific embodiment, the network connection comprises an Asynchronous Transfer Mode protocol (ATM). In another specific embodiment, the network connection comprises Resource Reservation Protocol (RSVP). In other specific embodiments, other network protocols, such as Digital Subscriber Line network (DSL), Integrated Services Digital Network (ISDN), and the like, are used. The terms data rate and data speed are used synonymously herein to refer to a rate at which data moves across a point in a path. Data rate can be measured in bits per second, millions of bits per second (Mb/sec.), and so forth.

In another representative specific embodiment, the invention provides a computer system that comprises a computational resource; a storage system; and a communication link. In specific embodiments, the computational resource is a host computer system. In alternative specific embodiments, the computational resource is a second storage system. As used herein, the term computational resource is to be broadly construed to include computers, computer peripherals, storage systems, and the like. The communication link connects the computational resource to the storage system. The computational resource establishes communications with the storage system using the communication link. The storage system allocates resources to the computational resource based upon a data rate capability of the storage resources and a data rate capability of the communication link. Resources can include storage space on storage disks, data paths interconnecting storage disks to network connections, and the like.

In specific embodiments, the storage system allocates storage resources, or data path resources, or both based upon a data rate capability of the storage resources and a data rate capability of the communication link.

In a specific embodiment, the communication link provides a guaranteed quality of service (QoS) communication. In some specific embodiments, the guaranteed QoS comprises a guaranteed bandwidth. In other specific embodiments, the guaranteed QoS comprises a guaranteed data rate. In these embodiments, the storage system allocates storage and/or data path resources based upon the guaranteed bandwidth and/or guaranteed data rate.

In a yet further representative specific embodiment, the invention provides a method for allocating resources in a storage system. The storage system comprises a storage and a network connection. The method comprises establishing a data path between the storage and the network connection. The data path is assigned a sufficient data speed based upon a data capacity of the storage and a data rate capability of the network connection. The method also includes allocating the storage based upon a data capacity of the storage and a data rate capability of the network connection. In a specific embodiment, the network connection provides a guaranteed quality of service (QoS) communications. In this embodiment, data paths having a sufficient data speed to accommodate the guaranteed quality of service are assigned to establish the data path between the storage and the network connection. Further, in specific embodiments, allocating storage comprises allocating storage having a sufficient data capacity to accommodate the guaranteed data rate. In specific embodiments, establishing a data path comprises searching for unallocated data communications resources to accommodate a data capacity of the storage. Further, in some specific embodiments, allocating storage comprises searching for unallocated storage having a sufficient data capacity to match a data rate capability of the network connection. In specific embodiments, tables are used to track available resources.

Numerous benefits are achieved by way of the present invention over conventional techniques. In specific embodiments, the present invention provides techniques for guaranteeing data access speed of storage connected by a network having guaranteed QoS (Quality of Services). Specific embodiments utilize network and storage resources more efficiently than conventional approaches. In specific embodiments, storage resources are matched to communications capabilities to provide for improved storage system throughput capability.

These and other benefits are described throughout the present specification. A further understanding of the nature and advantages of the invention herein may be realized by reference to the remaining portions of the specification and the attached drawings.

### BRIEF DESCRIPTION OF THE DRAWINGS

FIG. 1 shows a configuration of a representative storage system according to a specific embodiment of the present invention.

FIG. 2 shows in a block diagram of a representative allocation of programs in memory according to a specific embodiment of the present invention.

FIG. 3 shows a flow chart of a representative process for assigning a logical disk according to a specific embodiment of the present invention.

FIG. 4 shows a representative configuration table according to a specific embodiment of the present invention.

FIG. 5 shows a representative logical disk configuration table according to a specific embodiment of the present invention.

FIG. 6 shows a representative ECC group configuration table according to a specific embodiment of the present invention.

FIG. 7 shows a representative physical disk configuration table according to a specific embodiment of the present invention.

FIG. 8 shows schematically a representative ECC group according to a specific embodiment of the present invention.

FIG. 9 shows a representative embodiment of a communication configuration table according to a specific embodiment of the present invention.

FIG. 10 shows a flow diagram of representative storage system-to-host communication according to a specific embodiment of the present invention.

FIG. 11 shows a flow diagram of representative processing for a storage system according to a specific embodiment of the present invention.

FIGS. 12A-12B show flow diagrams of representative processing for storage initiator processes in a host and in a storage system, respectively, according to a specific embodiment of the present invention.

FIG. 13 shows a block diagram illustrating representative processing modules according to a specific embodiment of the present invention.

FIG. 14 shows a schematic diagram illustrating representative relationships between a storage system, a host, a data path, a communication link, and a data link according to a specific embodiment of the present invention.

FIG. 15 shows an exemplary sequence of the processing performed when a first storage system communicates with a second storage system according to a specific embodiments of the present invention.

FIG. 16 shows a schematic diagram illustrating representative relationships between a first storage system, a second storage system, a data path, a communication link, and a data link according to a specific embodiment of the present invention.

### DESCRIPTION OF THE SPECIFIC EMBODIMENTS

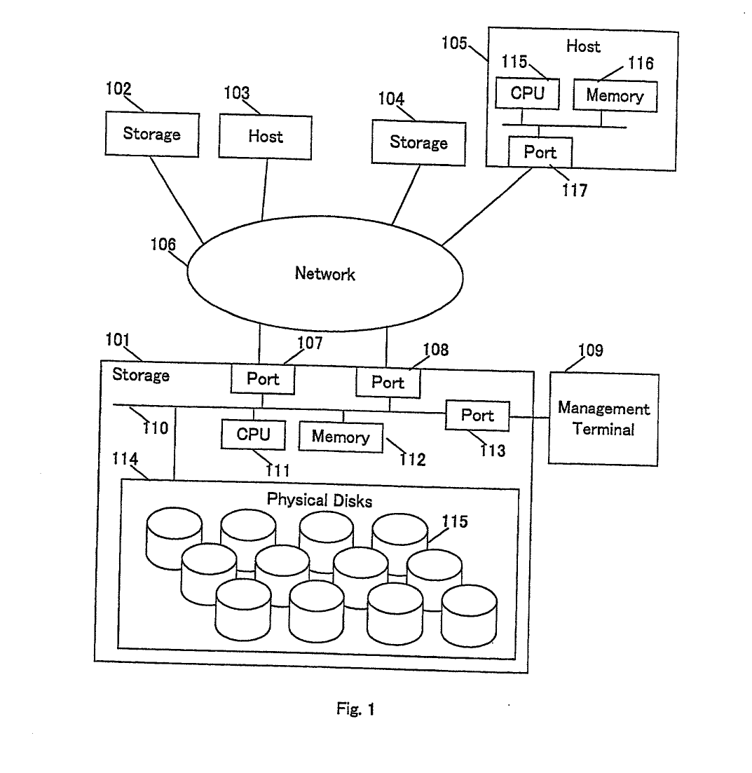

FIG. 1 shows a configuration of a representative storage system according to a specific embodiment of the present invention. The representative storage system 101 illustrated in FIG. 1 has communication ports 107 and 108 for connecting to network 106. The network 106 connects the storage system 101 to a variety of other devices and systems, such as a host 103, a host 105, and other storage systems 102. The network 106 provides guaranteed quality of service (QoS) communications capability for these devices. The guaranteed QoS capability is in accordance with, for example, a Resource Reservation Protocol (RSVP), such as described by RFC2205, which is incorporated herein by reference for all purposes. In alternative embodiments, other kinds of protocols may be used. Network 106 can be any of a variety of network topologies and protocols. For example, network 106 can be an Asynchronous Transfer Mode (ATM), Integrated Services Digital Network (ISDN), a Digital Subscriber Line network (DSL), or the like. For a detailed description of the ATM protocol, reference may be had to: (1) the ATM Forum (1994), ATM User Network Interface (UNI) Version 3.1, AF-UNI-0010.002; (2) the ATM Forum (1996), ATM User Network Interface (UNI) Version 4.0, AF-SIG-0061.000; and (3) the ATM Forum (1996), Native ATM Services: Semantic Description Version 1.0, AF-SAA-0048.000, which are incorporated herein by reference in their entirety for all purposes. Storage system 101 comprises various devices and processes. As illustrated by FIG. 1, storage system 101 comprises a plurality of physical disk storage units 115. Physical disk storage units 115 are connected to a CPU 111, and a memory 112 by a bus 110. Bus 110 connects to ports 107 and 108, as well. A management terminal 109 is connected to storage system 101 via a port 113, and provides a mechanism for defining a storage configuration. In an alternative embodiment, the management terminal 109 connects to storage system 101 via network 106, for example.

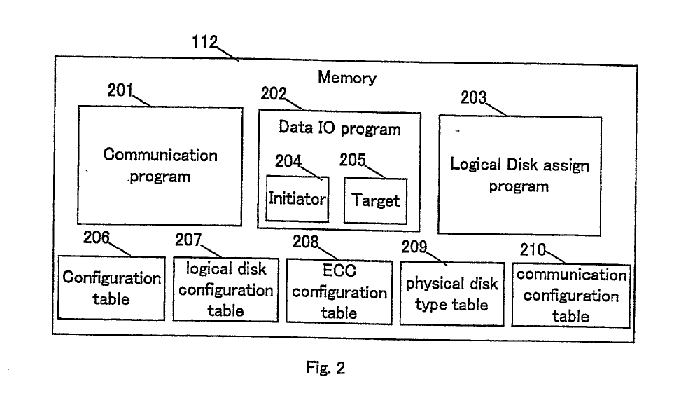

FIG. 2 shows in a block diagram of a representative allocation of programs in memory according to a specific embodiment of the present invention. FIG. 2 illustrates a plurality of program processes resident within memory 112 of storage system 101 shown in FIG. 1. These programs include, a communication program 201, a data IO program 202, and a logical disk assign program 203. A plurality of tables that store information about the allocations of resources are also resident within memory 112. These tables include a configuration table 206, a logical disk configuration table 207, an ECC configuration table 208, a physical disk type table 209 and a communication configuration table 210. Specific embodiments will include other program processes not shown in FIG. 2. Further, specific embodiments will not include all of the program processes shown, or may combine the functions described herein with respect to the program processes illustrated in FIG. 2 into other program processes, as will be readily understood by those of ordinary skill in the art. The functions of each of these tables and programs will next be described in detail below.

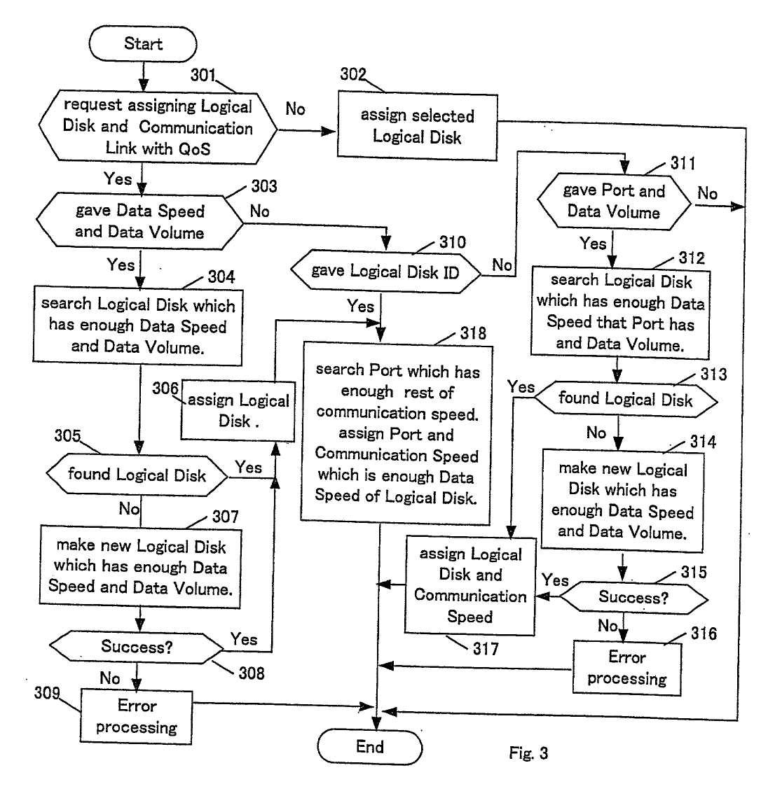

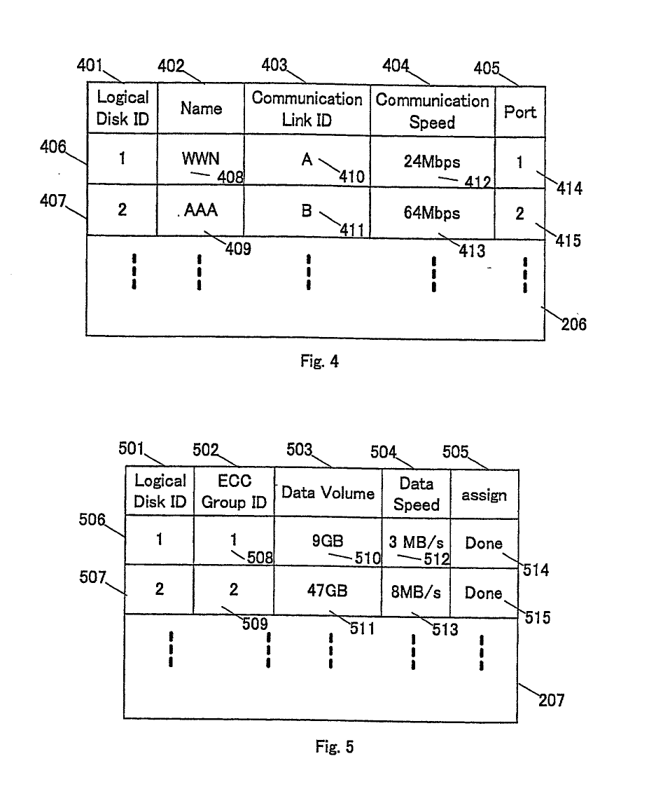

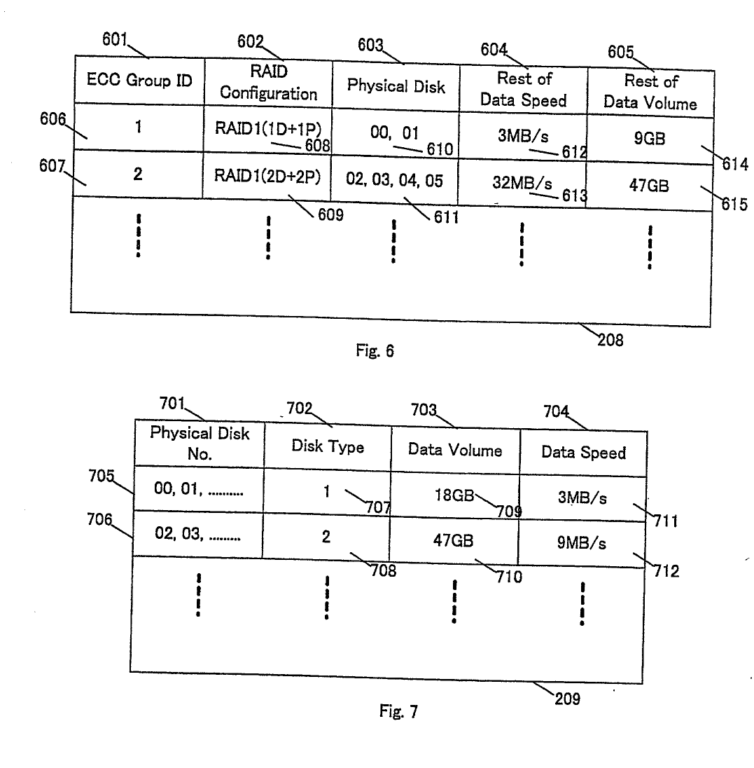

FIG. 3 shows a flow chart of a representative process for assigning a logical disk in a specific embodiment according to the present invention. The flowchart illustrated by FIG. 3 shows the processing of the logical disk assign program 203 of FIG. 2. Logical disk assign program 203 assigns a logical disk within the storage system 101 to a communication link and a host or other storage in communication with the storage system 101. FIG. 3 illustrates a step 301 in which a request is received and it is determined whether the request is for assigning a logical disk and a communication link having guaranteed QoS. If so, then in a step 303, it is determined whether the request includes a data speed and a data volume. If so, then in a step 304, the logical disk configuration table 207 is searched for a logical disk having sufficient speed and data volume. A representative embodiment of the logical disk configuration table 207 is illustrated in detail in FIG. 5. If a suitable logical disk is found, then in a step 306, that logical disk is assigned according to the request. Otherwise, if a suitable logical disk is not found in the logical disk configuration table 207, then in a step 307, the ECC configuration table 208 is searched for available resources from which a suitable disk may be created. A representative embodiment of the ECC configuration table 208 is illustrated in detail in FIG. 6. In a step 308, it is determined whether a logical disk was successfully created from the available resources of the ECC group controlled by the ECC configuration table 208. If a logical disk was successfully created, then in step 306, the new disk is assigned according to the request. Otherwise, in a step 309, error processing is performed. After the logical disk is assigned in step 306, then in a step 318, the configuration table 206 is searched to determine a port having sufficient communication speed for the capabilities of the logical disk. A representative embodiment of the configuration table 206 is illustrated in detail in FIG. 4. After the logical disk is assigned to a communication link and host or other storage in step 318, the logical disk assign configuration table 206 will be updated.

If, in step 301, it is determined that the request does not include a request for assigning a communication link with a guaranteed QoS, then, in a step 302, a suitable logical disk is assigned according to the request. Under this scenario, no further assignment processing is performed.

If, in step 303, the data speed and data volume where not provided in the request, then, in a step 310, it is determined whether a logical disk ID was included in the request. If so, then processing continues with step 318 as described above with the logical disk ID specified in the request. Otherwise, in a step 311, it is determined whether a port and a data volume where requested. If so, then in a step 312, the communication configuration table 210 is searched to determine if the requested port has sufficient communications capabilities to satisfy the request. A representative embodiment of the communications configuration table 210 is illustrated in FIG. 9. Further, the logical disk configuration table 207 is searched for a logical disk having sufficient speed and data volume to satisfy the request. If, in step 313, it is determined that a suitable logical disk is found, then in a step 317, that logical disk, as well as the communication port having sufficient speed to satisfy the requirements of the request, is assigned according to the request. Otherwise, if a suitable logical disk is not found in the logical disk configuration table 207, then in a step 314, the ECC configuration table 208 is searched for available resources from which a suitable disk may be created. In a step 315, it is determined whether a logical disk was successfully created from the available resources of the ECC group controlled by the ECC configuration table 208. If a logical disk was successfully created, then in step 317, the new disk, as well as the communication port, is assigned according to the request. Otherwise, in a step 316, error processing is performed.

FIG. 4 shows a representative configuration table according to a specific embodiment of the present invention. The configuration table of FIG. 4 comprises a plurality of entries for communication links. A communication link comprises a logical link that connects a storage system with a host or another storage system via a network, for example. The configuration table entries comprise a logical disk ID 401, a name 402, a communication link ID 403, a communication port 405, and optionally a communication speed 404. Name 402 comprises a communication partner, which is a WWN (World Wide Name), a host name, an IP address, or the like. When a communication link is assigned, entries are made in the table for a communication port 405, a name of a communication partner 402, and, if applicable, a communication speed 404. When a communication link uses a communication port 405 that connects to a network having guaranteed QoS capability, an entry for a communication speed 404 is also made in the table. A communication link ID 403 is provided after the communications are established.

FIG. 5 shows a representative logical disk configuration table according to a specific embodiment of the present invention. The logical disk configuration table illustrated by FIG. 5 comprises entries for one or more logical disk definitions. Each entry comprises a logical disk ID 501, an Error Checking and Correcting (ECC) group ID 502, a data volume 503, a data speed 504 and an indicator of whether the logical disk has been assigned 505. An ECC group is comprised of physical disks. A logical path in storage is a data path which is between a logical disk and a communication port. Speed of data along the logical path depends upon the data speed of a logical disk. Data speed of a logical disk depends upon the capabilities of one or more physical disks in the ECC group 502. For example, FIG. 5 illustrates a logical disk ID 1 506 having a data speed of 3 MB/second 512 that belongs to an ECC group 1 508. A second logical disk, having a logical disk ID 2 507, has a data speed of 8 MB/second 513 and belongs to ECC group ID 2 509.

FIG. 6 shows a representative ECC group configuration table according to a specific embodiment of the present invention. The ECC group configuration table illustrated by FIG. 6 comprises entries for one or more ECC groups. Each entry comprises an ECC group ID 601, a RAID configuration 602, a physical disk 603, a rest of data speed 604, and a rest of data volume 605. For example, ECC group ID 1 606 is comprised of two physical disks, physical disk 00 and physical disk 01 as illustrated by numeral 610. ECC group 1 has remaining resources of 3 MB/second remaining speed, indicated by numeral 612, and 9 GB of remaining volume, as indicated by numeral 614. The physical disks of ECC group ID 1 606 are comprised of one Data and one Parity check, as indicated by numeral 608. A second ECC group ID 2 607 is comprised of physical disks 02, 03, 04, and 05 as illustrated by numeral 611. ECC group 2 has available resources of 32 MB/second remaining speed, indicated by numeral 613, and 47 GB of remaining volume, as indicated by numeral 615.

FIG. 7 shows a representative physical disk configuration table according to a specific embodiment of the present invention. The physical disk configuration table illustrated by FIG. 7 comprises entries for one or more physical disks. Each entry comprises a physical disk number 701, a disk type 702, a data volume 703 and a data speed 704. Comparing the entries in the physical disk configuration table of FIG. 7 with those of the ECC group configuration table of FIG. 6, it can be determined that the type of the two physical disks comprising ECC group ID 1 606, physical disk 00 and physical disk 01, as indicated by numeral 610 in FIG. 6, is type 1, as indicated by numeral 707 in FIG. 7, corresponding to an entry for these physical disks 705 in the table. FIG. 7 further indicates that a data speed of type 1 disks is 3 MB/second (Mega Byte per second), as indicated by numeral 711. A data volume of type 1 disks is 18 GB (Giga Byte), as indicated by numeral 709. Thus, ECC group ID 1 606 has a total of 6 MB/second capability, as it is comprised of two physical disks, 00 and 01, each of 3 MB/second capability. Further, since ECC group ID 1 606 is comprised of the two physical disks, and each physical disk has 18 GB of remaining data volume capacity, as indicated by numeral 709, the ECC group ID 1 606 has a total of 36 GB data volume.

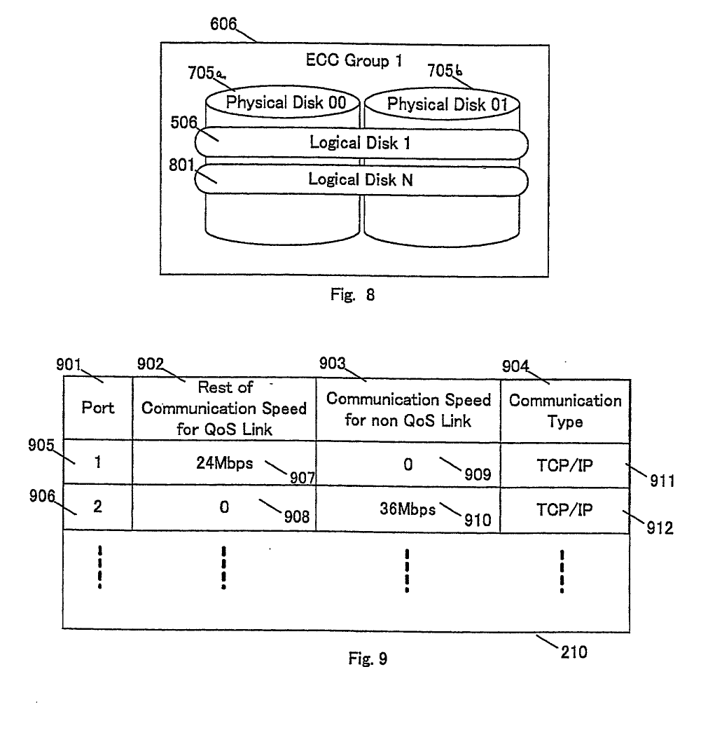

FIG. 8 shows schematically a representative ECC group according to a specific embodiment of the present invention. FIG. 8 shows ECC group 1 606 comprising of separate logical disks, logical disk 1 506 and logical disk N 801. The logical disks are mapped to physical disks, physical disk 00 705a and physical disk 01 705b. One technique for providing a logical/physical mapping function that converts a logical disk address specified by a host computer to a physical disk address is used in a redundant array of inexpensive disks (RAID) system. The RAID is described in further detail in Patterson et al., “A case for Redundant Arrays of Inexpensive Disks (RAID),” ACM SIGMOD Conference, Chicago, Jun. 1-3, 1988, which is incorporated herein by reference in its entirety for all purposes. In a RAID system, a logical disk specified by a host computer when it issues a read or write request, need not be completely coincident with a physical disk.

FIG. 9 shows a representative embodiment of a communication configuration table according to a specific embodiment of the present invention. As described above, when a logical disk is created, such as in steps 307 and 314, the ECC group configuration table illustrated by FIG. 6 is searched for data speed 604 and data volume 605 resources that are available for the ECC group 606. Similarly, when communication speed is assigned, such as in step 318, the communication configuration table in FIG. 9 is searched for available resources, both for a communication speed for a QoS link 902, or a communication speed for a non-QoS link 903, for the ECC group 606. If an appropriate communication port to connect to the network has guaranteed QoS capability, then available communication speed is drawn from the rest of communication speed for QoS link 902. Otherwise, the available communication speed from the communication speed for a non QoS link 903 is drawn upon. For example, communications port 1 905 is comprised of a QoS communication link having 24 Mbps of available communications data speed, as illustrated by numeral 907. Communications port 2 is comprised of a non-QoS communication link that has remaining resources of 36 Mbps of data speed, as indicated by numeral 910. If a communication port is used for a QoS link and a non-QoS link, then the communication speed of the port is separated, as indicated by numerals 902 and 903 in communication configuration table of FIG. 9.

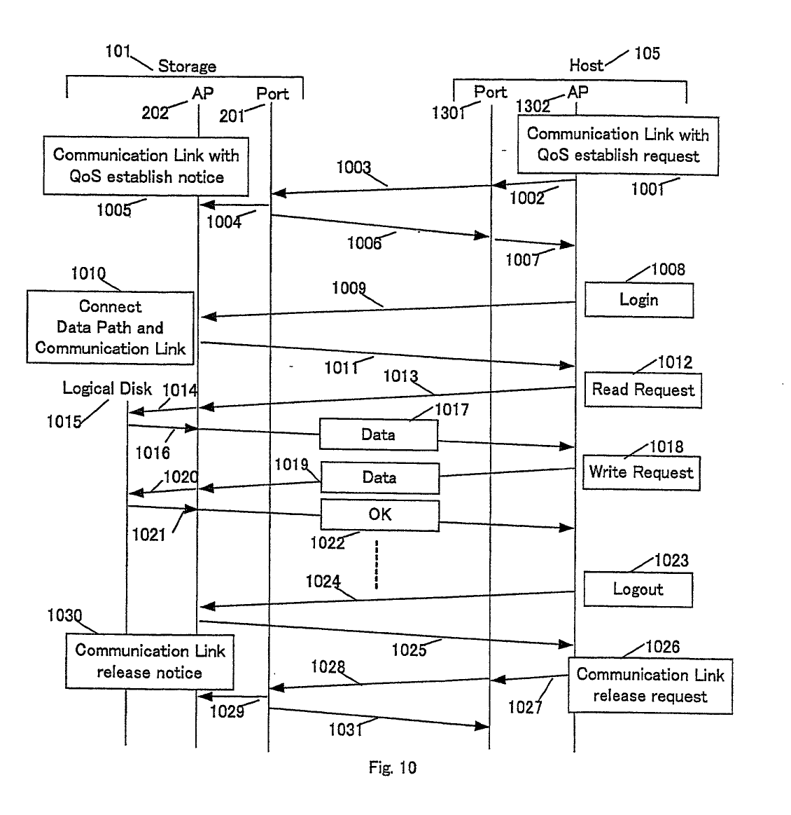

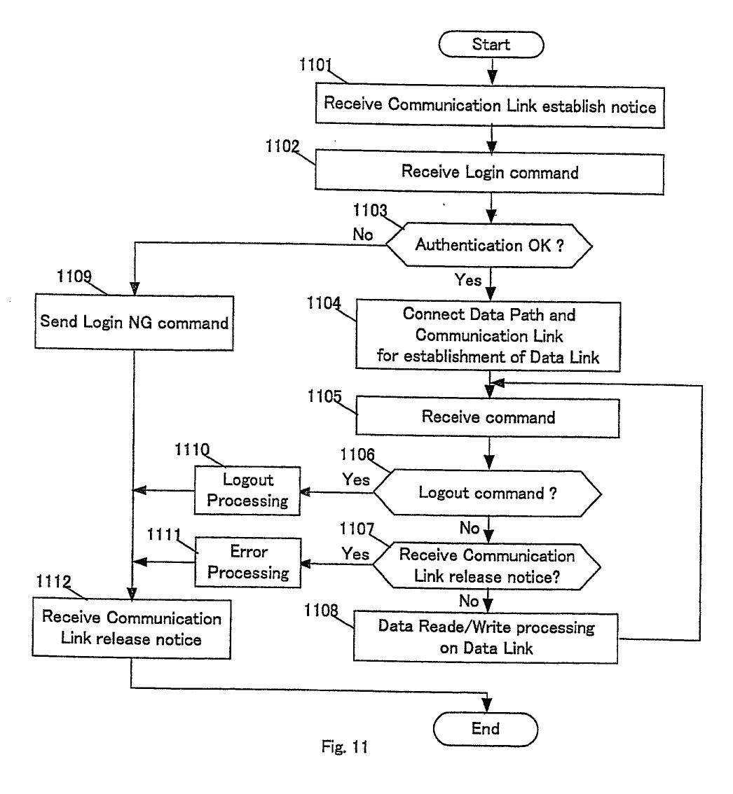

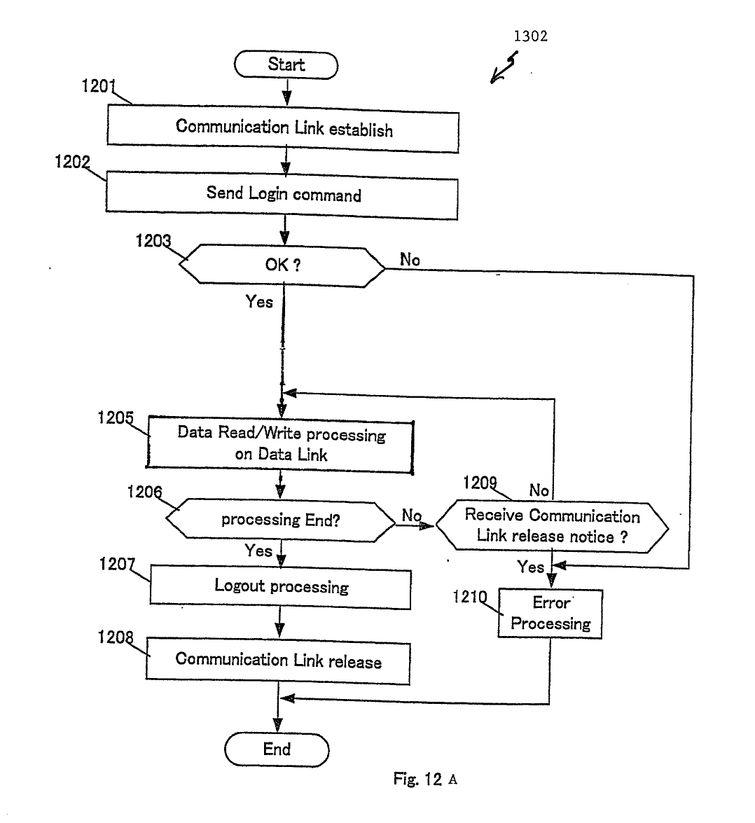

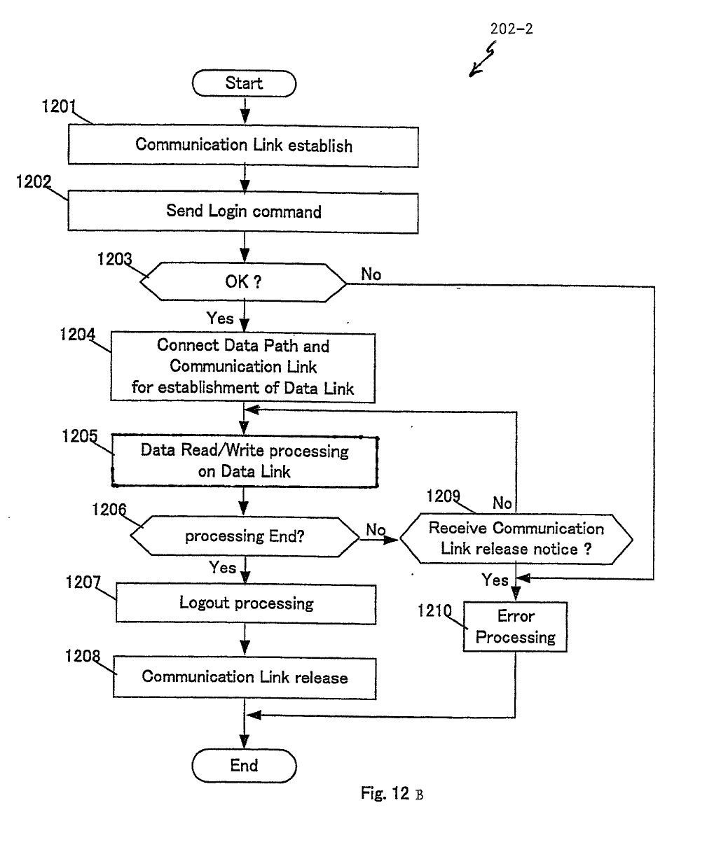

FIG. 10 shows a flow diagram of representative storage system-to-host communication according to a specific embodiment of the present invention. In FIG. 10, storage system 101 communicates with host 105. The target program 205 in the data IO program 202 shown in FIG. 2 is denoted by an “AP.” The processing performed by data IO program 202 is illustrated by FIG. 11. The processing performed by the data IO program 1302 is illustrated by FIG. 12A. The communication program 201 shown in FIG. 2 is denoted by “Port.” The interface between the AP and the Port comprises a plurality of communications, denoted by 1002, 1004, 1007, 1027, and 1029 in FIG. 10. Communications between the Port 201 and the Port 1301, of the storage system 101 and the host 105, respectively, comprises a plurality of transactions, denoted by 1003, 1006, 1028, and 1031. These transactions are defined by the interface commands of the communication protocol employed by communication program 201. In a presently preferred embodiment, the network supports RSVP (Resource Reservation Protocol), and the commands and transactions illustrated in FIG. 10 are defined by the RSVP. In a specific embodiment, the network supports ATM, Asynchronous Transfer Mode, and these commands are defined by ATM protocol. In another specific embodiment, the network is an ISDN, Integrated Services Digital Network, and these command are defined by the ISDN. In a yet further specific embodiment, the network is a Digital Subscriber Line network (DSL).

FIG. 10 illustrates data IO program 1302 executing on host 105 preparing a communication link with QoS establish request 1001, and forwarding this request to port 1301 of the host 105, as indicated by numeral 1002. The port 1301 sends a communication link with QoS establish request command to the port 201 of storage system 101, as indicated by numeral 1003. Port 201 notifies the data IO program 202 executing on storage system 101 of the request command 1003 from host 105, as indicated by 1004. The port 201 also sends an acknowledgment to the port 1301 of host 105, as indicated by numeral 1006. Port 1301 sends a communication link establish 1007 to data IO program 1302 on host 105. At this point, a communication link has been established between host 105 and storage system 101.

Once a communication link is established between the host 105 and storage system 101, the data IO program 1302 of the host 105 and data IO program 202 of the storage system 101 can send and receive commands and information on that communication link. Ports 201 and 1301 do not examine the kind of data sent across the communication link. In FIG. 10, the data IO program 1302 in host 105 sends a login request 1008 to the data IO program 202 in storage system 101, as indicated by numeral 1009. The data IO program 202 in storage system 101 connects a data path between the port 201 and a logical disk 1015, as indicated by numeral 1010. Data IO program 202 sends an acknowledgment to data IO program 1302 in host 105, as indicated by 1011. The host 105 is now able to make requests of the logical disk 1015 in the storage system 101. The data IO program 1302 of the host 105 makes a read request 1012, which is forwarded to the data IO program 202 in storage system 101, as indicated by numeral 1013. The data IO program 202 in storage system 101 forwards the request to logical disk 1015 along the data path, as indicated by numeral 1014. Logical disk 1015 processes the request and returns the data to data IO program 202 along the data path, as indicated by numeral 1016. The data IO program 202 forwards the data 1017 to the data IO program 1302 in host 105. The data IO program 1302 of host 105 makes a write request 1018, which is forwarded to the data IO program 202 in storage system 101, as indicated by 1019. The data IO program 202 in storage system 101 forwards the request to the logical disk 1015 along the data path, as indicated by numeral 1020. Logical disk 1015 processes the request and returns an acknowledgment to data IO program 202 along the data path, as indicated by numeral 1021. The data IO program 202 in storage system 101 forwards the acknowledgment to the data IO program 1302 in host 105, as indicated by numeral 1022. In this manner, host 105 and storage system 101 process all read/write transactions.

Once no further read/write transactions are to be processed, the data IO program 1302 in host 105 initiates a logout procedure 1023. The data IO program 1302 in host 105 sends a logout message to the data IO program 202 in storage system 101, as indicated by numeral 1024. The data IO program 202 in storage system 101 sends an acknowledgment to the data IO program 1302 in host 105, as indicated by numeral 1025. When the data IO program 1302 in host 105 is finished communicating with storage system 101 altogether, the data IO program 1302 sends a communication link release request 1026 to port 1301 within the host 105, as indicated by numeral 1027. Port 1301 of host 105 sends a communication link release request command to port 201 of storage system 101, as indicated by numeral 1028. Port 201 sends a communication link release notification to data IO program 202 in storage system 101, as indicated by numeral 1029. The data IO program 202 releases storage and communication resources allocated to the session with the host 105, as indicated by numeral 1030. Then, data IO program 202 sends an acknowledgment to the host 105, as indicated by numeral 1031.

Table 1 provides a summary of the representative protocol used for communication between the host 105 and the storage system 101 of the specific embodiment illustrated in FIG. 10:

TABLE 1

| Number | Function | Transaction |
|---|---|---|
| 1002 | AP requests to Port | Communication Link with |
| | | QoS establish |
| 1003 | Port send to Port | Communication Link with |
| | | QoS establish request |
| | | command |
| 1004 | Port notices to AP | Communication Link |
| | | establish |
| 1006 | Port sends to Port | OK response command |
| 1007 | Port replies to AP | Communication Link |
| | | establish |
| 1027 | AP requests to Port | Communication Link release |
| 1028 | Port sends to Port | Communication Link release |
| | | request command |
| 1029 | Port notices to AP | Communication Link release |
| 1031 | Port sends to Port | OK response command |

FIG. 11 shows a flow diagram of representative processing for a storage system according to a specific embodiment of the present invention. In a specific embodiment, the storage system processing is embodied in a target program 205 within data IO program 202, denoted “AP” in FIG. 10. Data IO program 202 communicates with a host or another storage system via communication program 201, denoted “Port” in FIG. 10, and stores information to and retrieves information from configuration table 206. The processing of target program 205 is invoked responsive to receiving a communication link with QoS establish notice 1005 from communications program 201 (i.e., Port 201). The port 201 sends notice 1005 to the target program 205 when the port 201 receives a communication link with QoS establish request 1001 from a host 105, or another storage system.

In a step 1101, the storage system receives the communication link establish notice 1005 from port 201 as shown by 1004 in FIG. 10. The port 201 sends an acknowledgment to the port 1301 of host 105. At this point, the host 105 and storage system 101 have established a communications connection, allowing them to transfer information between one another. In a step 1102, a login request 1008 is received by storage system 101 from host 105. In a decisional step 1103, the login request is authenticated. If the login is determined to be authentic, then in a step 1104, the storage system 101 connects a data path to a logical disk and communication link to establish a data link, as indicated by numeral 1010 in FIG. 10. In the event that the login was unable to be authenticated in step 1103, a send login No Good command 1109 is processed. After a successful login, data path and communication link resources are made available to host 105 and a command processing loop is entered. In a step 1105, a command is received. The command can be a request to read data from, or to write data to, the logical disk, a logout command, and the like, for example. In a decisional step 1106, the command is checked to see if it is a logout command. If so, then in a step 1110, a logout processing is performed. Otherwise, in a decisional step 1107, the command is checked to see if it is a communication link release notice. If so, then in step 1111, error processing is performed. Otherwise, processing continues with a step 1108, in which read/write commands from the host 105 are processed. After completion of step 1108, processing resumes at the beginning of the command processing loop with step 1105.

If a login No Good command has been processed in step 1109, or a logout command was processed in step 1110, or a communication link release notice was processed in step 1111, then in a step 1112, a receive communication link release notice 1030 is received from port 201. The port 201 generates this communication release notice 1030 responsive to receiving a communication link release request 1026 from host 105. Receipt of the communication release notice 1030 causes processing for this communication session to terminate.

FIG. 12A shows a flow diagram of representative processing for a host system according to a specific embodiment of the present invention. In a specific embodiment, the host system processing is embodied in the data IO program 1302, denoted “AP” in FIG. 10. Data IO program 1302 communicates with a storage system 101 via communication program 1301, denoted “Port” in FIG. 10.

In a step 1201, the data IO program 1302 is invoked to send a communication link with QoS establish request 1001 to the port 1301, as denoted by 1002 in FIG. 10. The port 1301 sends a communication link with QoS establish request command to a storage system 101, as denoted by 1003 in FIG. 10. Processing in the storage system returns an acknowledgment 1006 to port 1301, which in turn sends a communication link establish notice 1007 to data IO program 1302. Then in a step 1202, a login request 1008 is sent to the storage system 101, as denoted by 1009 in FIG. 10. In a decisional step 1203, the response to the login request is authenticated. If the login is successful, then the storage system 101 connects a data path to a logical disk and communication link to establish a data link and sends a notice indicating completion 1011. In the event that the login was unable to be authenticated in step 1203, error processing is performed in a step 1210. After a successful login, a command processing loop beginning with step 1205 is entered. In a step 1205, commands are issued to the storage system 101 to perform data read and write processing over the data link. In a decisional step 1206, status of command processing is checked to see if command processing has ended. If so, then in a step 1207, logout processing is performed. Otherwise, in a decisional step 1209, the command is checked to see if it is a communication link release notice. If so, then in step 1210 error processing is performed. Otherwise, processing continues with a step 1205, in which further read/write commands are processed. If a communication link release notice was processed in step 1210, then processing for this communications session terminates.

In an alternative embodiment, in which the storage system does not authenticate a communication partner, steps 1008, 1009, 1011, 1023, 1024, and 1025 in FIG. 10, steps 1102, 1103, 1106, 1109, and 1110 in FIG. 11, and steps 1202, 1203, and 1207 in FIG. 12A are omitted.

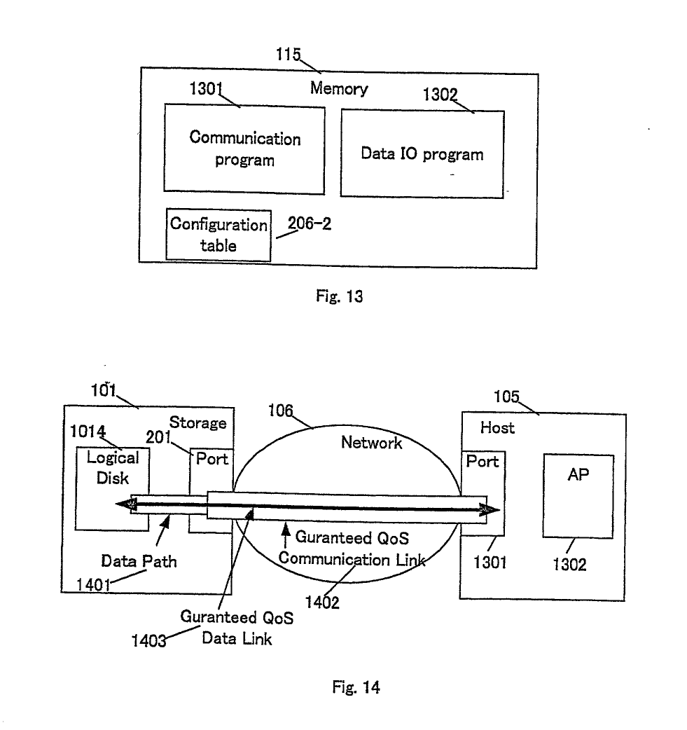

FIG. 13 shows a block diagram illustrating representative processing modules in host 105 according to a specific embodiment of the present invention. As shown by FIG. 13, the communication program 1301 and the data IO program 1302 reside in memory 115 of host 105. The data IO program 1302 accesses the configuration table 206-2 to maintain state of the system. The functioning and relationships of these components has been described above with reference to FIGS. 10-12A.

FIG. 14 shows a schematic diagram illustrating representative relationships between a storage system, a host, a data path, a communication link, and a data link according to a specific embodiment of the present invention. As shown by FIG. 14, a storage system 101 is connected with a host 105 by a data path 1401, and a communication link 1402. A data link 1403, comprising of the data path and the communication link, is established according to processing performed by a target program 205 of data IO program 202, as described above with reference to FIGS. 10-12A. Data is sent and received on data link 1403. When data link 1403 is made with a guaranteed QoS communication link and a guaranteed QoS data link, a data access speed is guaranteed.

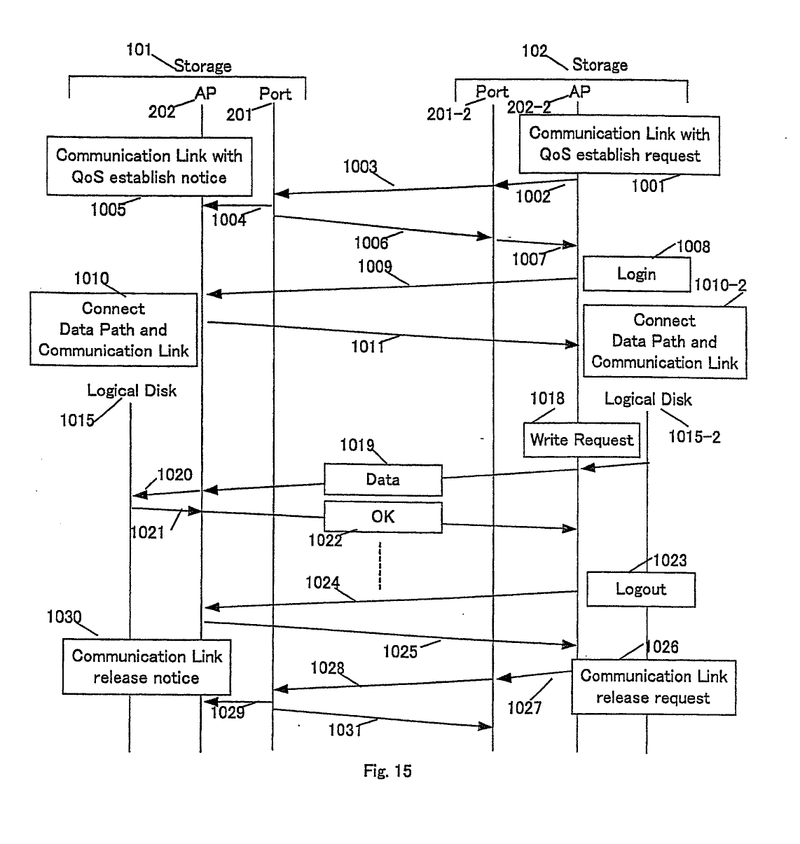

FIG. 15 shows an exemplary sequence of the processing performed when a first storage system communicates with a second storage system according to a specific embodiments of the present invention. A storage 101 performs processing according to the flow chart in FIG. 11. The target program 205 within the data IO program 202 uses configuration table 206 to manage system resources. The second storage system 102 performs processing according to the flow chart in FIG. 12B. An initiator program 204 within the data IO program 202 uses configuration table 206 to manage system resources.

As shown by FIG. 15, a data IO program 202-2 executing on storage system 102 prepares a communication link with QoS establish request 1001, and forwards this request to port 201-2 of the storage system 102, as indicated by numeral 1002. The port 201-2 sends a communication link with QoS establish request command to the port 201 of storage system 101, as indicated by numeral 1003. Port 201 notifies the data IO program 202 executing on storage system 101 of the request command 1003 from storage system 102, as indicated by 1004. The port 201 also sends an acknowledgment to the port 201-2 of storage system 102, as indicated by numeral 1006. Port 202-1 sends a communication link establish 1007 to data IO program 202-2 on storage system 102. At this point, a communication link has been established between storage system 102 and storage system 101.

Once a communication link is established between the storage system 102 and storage system 101, the data IO program 202-2 of the storage system 102 and data IO program 202 of the storage system 101 can send and receive commands and information on that communication link. Ports 201 and 201-2 do not examine the kind of data sent across the communication link. In FIG. 15, the data IO program 202-2 in storage system 102 sends a login request 1008 to the data IO program 202 in storage system 101, as indicated by numeral 1009. The data IO program 202 in storage system 101 connects a data path between the port 201 and a logical disk 1015, as indicated by numeral 1010. Data IO program 202 sends an acknowledgment to data IO program 202-2 in host 105, as indicated by 1011. The data IO program 202-2 in storage system 102 also connects a data path between the port 201-2 and a logical disk 1015-2, as indicated by numeral 1010-2. This corresponds to step 1204 illustrated by FIG. 12B. This step is performed by the requestor storage system in a storage system-to-storage system communications session. The storage system 102 is now able to make requests of the logical disk 1015 in the storage system 101. The data IO program 202-2 of storage system 102 makes a write request 1018, which is forwarded to the data IO program 202 in storage system 101, as indicated by 1019. The data IO program 202 in storage system 101 forwards the request to the logical disk 1015 along the data path, as indicated by numeral 1020. Logical disk 1015 processes the request and returns an acknowledgment to data IO program 202 along the data path, as indicated by numeral 1021. The data IO program 202 in storage system 101 forwards the acknowledgment to the data IO program 202-2 in storage system 102, as indicated by numeral 1022. In this manner, storage system 102 and storage system 101 process all read/write transactions.

Once no further read/write transactions are to be processed, the data IO program 202-2 in storage system 102 initiates a logout procedure 1023. The data IO program 202-2 in storage system 102 sends a logout message to the data IO program 202 in storage system 101, as indicated by numeral 1024. The data IO program 202 in storage system 101 sends an acknowledgment to the data IO program 202-2 in storage system 102, as indicated by numeral 1025. When the data IO program 202-2 in storage system 102 is finished communicating with storage system 101 altogether, the data IO program 202-2 sends a communication link release request 1026 to port 201-2 within the storage system 102, as indicated by numeral 1027. Port 201-2 of storage system 102 sends a communication link release request command to port 201 of storage system 101, as indicated by numeral 1028. Port 201 sends a communication link release notification to data IO program 202 in storage system 101, as indicated by numeral 1029. The data IO program 202 releases storage and communication resources allocated to the session with the storage system 102, and sends an acknowledgment to the storage system 102, as indicated by numeral 1031.

FIG. 12B shows a flow diagram of representative processing for a storage system according to a specific embodiment of the present invention. In a specific embodiment, the storage system processing is embodied in the data IO program 202-2, denoted “AP” in FIG. 15. Data IO program 202-2 communicates with a storage system 101 via communication program 201-2, denoted “Port” in FIG. 15.

In a step 1201, the data IO program 202-2 is invoked to send a communication link with QoS establish request 1001 to the port 201-1, as denoted by 1002 in FIG. 15. The port 201-1 sends a communication link with QoS establish request command to a storage system 101, as denoted by 1003 in FIG. 15. Processing in the storage system returns an acknowledgment 1006 to port 201-1, which in turn sends a communication link establish notice 1007 to data IO program 202-2. Then in a step 1202, a login request 1008 is sent to the storage system 101, as denoted by 1009 in FIG. 15. In a decisional step 1203, the response to the login request is authenticated. If the login is successful, then the storage system 101 connects a data path to a logical disk and communication link to establish a data link and sends a notice indicating completion 1011. In the event that the login was unable to be authenticated in step 1203, error processing is performed in a step 1210. After a successful login, in a step 1204, the data IO program 202-2 in storage system 102 also connects a data path between the port 201-2 and a logical disk 1015-2, as indicated by numeral 1010-2. Next, a command processing loop beginning with step 1205 is entered. In a step 1205, commands are issued to the storage system 101 to perform data read and write processing over the data link. In a decisional step 1206, status of command processing is checked to see if command processing has ended. If so, then in a step 1207, logout processing is performed. Otherwise, in a decisional step 1209, the command is checked to see if it is a communication link release notice. If so, then in step 1210 error processing is performed. Otherwise, processing continues with a step 1205, in which further read/write commands are processed. If a communication link release notice was processed in step 1210, then processing for this communications session terminates.

In an alternative embodiment, in which the storage system does not authenticate a communication partner, steps 1008, 1009, 1011, 1023, 1024, and 1025 in FIG. 15, steps 1102, 1103, 1106, 1109, and 1110 in FIG. 11, and steps 1202, 1203, and 1207 in FIG. 12B are omitted.

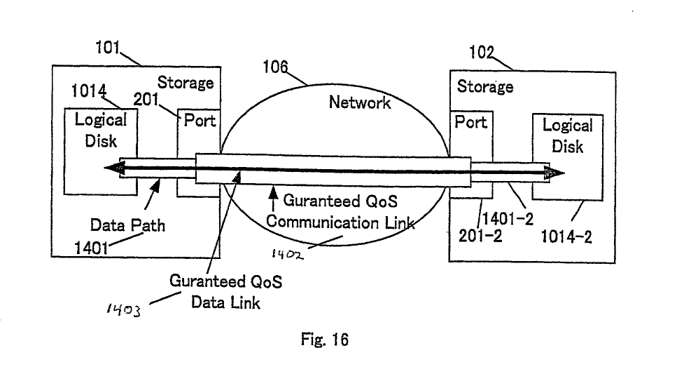

FIG. 16 shows a schematic diagram illustrating representative relationships between a first storage system, a second storage system, a data path, a communication link, and a data link according to a specific embodiment of the present invention. As shown by FIG. 16, a first storage system 101 is connected with a second storage system 102 by data paths 1401, 1401-2, and a communication link 1402. A data link 1403, comprising of the data paths 1401 and 1401-2 and the communication link 1402, is established according to processing performed by an initiator program 204 and a target program 205 of FIG. 2, as described above with reference to FIGS. 11, 12 and 15. Data is sent and received on data link 1403. When data link 1403 is made with a guaranteed QoS communication link and a guaranteed QoS data link, a data access speed is guaranteed.

Specific embodiments of the invention have a goal of providing a guaranteed data access speed to users of storage systems over networks.

As described above, the present invention provides techniques for providing a guaranteed data access speed in storage systems connected by networks.

As further described above, the present invention provides techniques for assigning communication speed and disks in storage which fit user request data access speed. Further, as described above, the present invention provides techniques for assigning communication resources based upon data throughput having sufficient data speed to accommodate the data access speed of disks in storage. Specific embodiments may also assign disks in storage that have sufficient data access speed to accommodate a communication data speed of network resources. In specific embodiments, the invention provides systems, methods, apparatus and computer code that enable using storage and communication resources more efficiently.

Although specific embodiments of the invention have been described, various modifications, alterations, alternative constructions, and equivalents are also encompassed within the scope of the invention. The described invention is not restricted to operation within certain specific data processing environments, but is free to operate within a plurality of data processing environments. Additionally, although the present invention has been described using a particular series of transactions and steps, it should be apparent to those skilled in the art that the scope of the present invention is not limited to the described series of transactions and steps.

Further, while the present invention has been described using a particular combination of hardware and software, it should be recognized that other combinations of hardware and software are also within the scope of the present invention. The present invention may be implemented only in hardware or only in software or using combinations thereof.

The specification and drawings are, accordingly, to be regarded in an illustrative rather than a restrictive sense. It will, however, be evident that additions, subtractions, deletions, and other modifications and changes may be made thereunto without departing from the broader spirit and scope of the invention as set forth in the claims.

What is claimed is:

1. A computer system comprising:
a computational resource;
a storage system; and
a communication link connecting said computational resource and said storage system; wherein said computational resource establishes communications with said storage system using said communication link; and
wherein said storage system allocates resources to said computational resource based upon a data rate capability of said storage resources and a data rate capability of said communication link.

2. The system of claim 1, wherein said computational resource is a host system.

3. The system of claim 1, wherein said computational resource is a second storage system.

4. The system of claim 1, wherein said storage system allocates storage resources to said computational resource based upon a data rate capability of said storage resources and a data rate capability of said communication link.

5. The system of claim 4, wherein said communication link provides a guaranteed quality of service (QoS) communication.

6. The system of claim 5, wherein said guaranteed quality of service (QoS) communication comprises a guaranteed data rate; and wherein said storage system allocates storage resources based upon said guaranteed data rate.

7. The system of claim 6, wherein said guaranteed quality of service (QoS) communication comprises a guaranteed bandwidth; and wherein said storage system allocates storage resources based upon said guaranteed bandwidth.

8. The system of claim 1, wherein said storage system allocates data path resources to said computational resource based upon a data rate capability of said storage resources and a data rate capability of said communication link.

9. The system of claim 8, wherein said communication link provides a guaranteed quality of service (QoS) communication.

10. The system of claim 9, wherein said guaranteed quality of service (QoS) communication comprises a guaranteed data rate; and wherein said storage system allocates data path resources based upon said guaranteed data rate.

11. The system of claim 10, wherein said guaranteed quality of service (QoS) communication comprises a guaranteed bandwidth; and wherein said storage system allocates data path resources based upon said guaranteed bandwidth.

12 An apparatus comprising:
a processor;
a storage; and
a network connection, operable to connect said apparatus at a guaranteed quality of service (QoS); and
wherein said processor establishes a data path between said storage and said network connection; said data path being assigned a sufficient data speed to accommodate said guaranteed quality of service.

13. The apparatus of claim 12, wherein said network connection comprises Asynchronous Transfer Mode (ATM).

14. The apparatus of claim 12, wherein said network connection comprises Integrated Services Digital Network (ISDN).

15. The apparatus of claim 12, wherein said network connection comprises Digital Subscriber Line network (DSL).

16. The apparatus of claim 12, wherein said network connection comprises Resource Reservation Protocol (RSVP).

17 A method for allocating resources in a storage system, said storage system comprising a storage and a network connection, said method comprising:
establishing a data path between said storage and said network connection; said data path being assigned a sufficient data speed based upon a data capacity of said storage and a data rate capability of said network connection; and
allocating said storage based upon a data capacity of said storage and a data rate capability of said network connection.

18. The method of claim 17, wherein said network connection provides a guaranteed quality of service (QoS) communication, wherein establishing said data path comprises assigning a data path having a sufficient data speed to accommodate said guaranteed quality of service.

19. The method of claim 17, wherein said network connection provides a guaranteed quality of service (QoS) communication, wherein allocating storage comprises allocating storage having a sufficient data capacity to accommodate said guaranteed data rate.

20. The method of claim 17, wherein said establishing a data path comprises:
searching for unallocated data communications resources to accommodate a data capacity of said storage.

21. The method of claim 17, wherein said allocating storage comprises:
searching for unallocated storage having a sufficient data capacity to match a data rate capability of said network connection.
